(19) United States
(12) Patent Application Publication
(10) Pub. No.: US 2006/0104260 A1
(43) Pub. Date: May 18, 2006

(54) Method and apparatus for continuous communication amongst endpoints of a communication system

(76) Inventors: Marian Croak, Fair Haven, NJ (US); Hossein Eslambolchi, Los Altos Hills, CA (US)

Correspondence Address: Mr. S.H. Dworetsky;AT&T Corp., Room 2A-207, One AT&T Way, Bedminster, NJ, 07921, US

(21) Appl. No.: 10/990,218

(22) Filed: Nov. 16, 2004

(51) Int. Cl. H04L 12/66

(52) U.S. Cl. 370/352

(57) ABSTRACT

Method and apparatus for communication amongst a plurality of endpoints is described. In one example, a logical communication channel is established amongst a plurality of endpoints. The logical communication channel is implemented using at least one physical link of at least one communication network. At least one initial media stream is propagated within the logical channel at a first time. At a second time, at least one media stream is bridged onto, and/or removed from, the logical communication channel without establishing another logical communication channel. In another example, a logical communication channel is established amongst a plurality of endpoints. The logical communication channel is implemented using a first physical link. A first media stream is propagated within the logical channel at a first time. At a second time, the logical communication channel is switched from the first physical link to a second physical link without establishing another logical communication channel.

### BACKGROUND OF THE INVENTION

1. Field of the Invention

Embodiments of the present invention generally relate to telecommunications systems and, more particularly, to a method and apparatus for continuous communication amongst endpoints of a communication system.

2. Description of the Related Art

Generally, telecommunications systems provide the ability for two or more people or machines (e.g., computerized or other electronic devices) to communicate with each other. A telecommunications system may include various networks for facilitating communication that may be generally organized into packet-switched networks and circuit-switched networks. Exemplary packet-switched networks include internet protocol (IP) networks, asynchronous transfer mode (ATM) networks, frame-relay networks, and the like. An exemplary circuit-switched network includes a plain old telephone system (POTS), such as the publicly switched telephone network (PSTN).

Users engaged in a dialogue communication using a particular type of media may at the convenience of any participant need to, or desire to, vary the type of media used during the conversation. For example, a user engaged in an instant messaging session may need to switch to a cellular phone conversation. Presently, once a communication channel is established between users, the communication channel must be explicitly reestablished or another communication channel must be explicitly established in order to switch the media type used for the communication stream.

Accordingly, there exists a need in the art for a method and apparatus for continuous communication streams across switching media types in a communication system.

### SUMMARY OF THE INVENTION

Method and apparatus for communication amongst a plurality of endpoints is described. In one embodiment, a logical communication channel is established amongst a plurality of endpoints. The logical communication channel is implemented using at least one physical communication link of at least one communication network. At least one initial media stream is propagated within the logical communication channel at a first time. At a second time, at least one media stream is bridged onto, and/or removed from, the logical communication channel without establishing another logical communication channel.

In another embodiment, a logical communication channel is established amongst a plurality of endpoints. The logical communication channel is implemented using a first physical communication link. A first media stream is propagated within the logical communication channel at a first time. At a second time, the logical communication channel is switched from the first physical communication link to a second physical communication link without establishing another logical communication channel.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a communication system in accordance with the invention;

FIG. 2 is a flow diagram depicting an exemplary embodiment of a method for communication amongst a plurality of endpoints in accordance with the invention;

FIG. 3 is a flow diagram depicting another exemplary embodiment of a method for communication amongst a plurality of endpoints in accordance with the invention; and

FIG. 4 is a block diagram depicting an exemplary embodiment of a computer suitable for implementing the processes and methods described herein.

### DETAILED DESCRIPTION

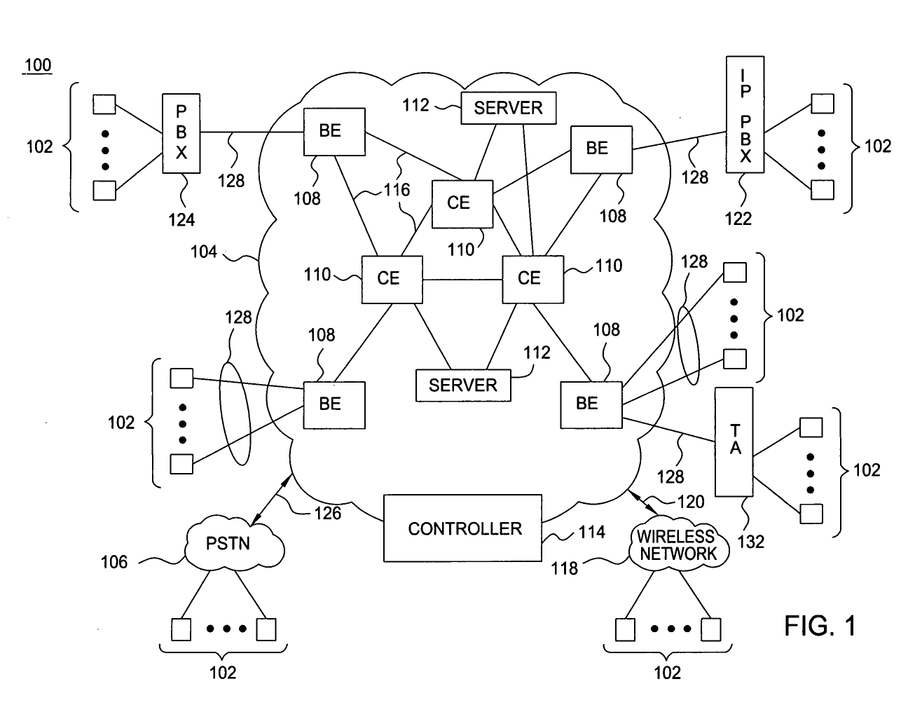

FIG. 1 depicts an exemplary embodiment of a communication system 100 in accordance with the invention. The communication system 100 comprises a plurality of user elements (UEs) 102, a packet-switched network 104, and a circuit-switched network (“publicly switched telephone network (PSTN) 106”), and a wireless communication network 118 (e.g., a cellular telephone network). The packet switched network 104, the PSTN 106, and the wireless network 118 collectively comprise a service provider network through which the user elements 102 may communicate with one another. The packet-switched network 104 illustratively comprises a plurality of border elements (BEs) 108, a plurality of core elements (CEs) 110, a plurality of servers 112, and a controller 114. The border elements 106, the core elements 110, and the servers 112 communicate via core communication links 116. The packet-switched network 104 may comprise one or more of an internet protocol (IP) network, asynchronous transfer mode (ATM) network, frame relay network, and like type packet networks known in the art. The packet-switched network 104 may comprise, for example, a voice-over-IP (VOIP) network. The details of the PSTN 106 and the wireless network 118 are well known in the art and are thus not repeated herein for clarity.

A core element is a network element (such as a router, switch, cross-connect system, server, and the like) that facilitates control and communication between the border elements 106 and the servers 112. A border element is a network element (such as a router, switch, cross-connect system, server, and the like) through which the user elements 102 connect to the packet-switched network 104. A border element typically performs functions such as routing, switching, security, admission control, and the like. In one embodiment, a border element translates access protocols into Session Initiation Protocol (SIP), which is then used to facilitate communication within a service provider IP infrastructure. The servers 112 may include various types of media servers (e.g., audio/video streaming servers) and the like.

For purposes of clarity by example, only three core elements 110 are depicted in FIG. 1. It is to be understood that the packet-switched network 104 may include fewer or more core elements 110. Similarly, although four border elements 108 and two servers 112 are depicted in FIG. 1 by example, the packet-switched network 104 may include fewer or more border elements and servers. Although the border elements 108 are depicted as being directly connected to the core elements 110, other intervening equipment (not shown) may be deployed.

A user element is typically a user terminal (such as a telephone, computer, and the like) by which one or more users communicate with other users in the communication system 100. Some of the user elements 102 communicate with the border elements 108 via edge communication links 128. A user element (such as a time division multiplexing (TDM) phone, an IP phone, an Integrated Services Digital Network (ISDN) phone, a computer, and the like) is able to establish a connection with a border element through a communication link 128. The PSTN 106 is coupled to the packet-switched network 104 via a communication link 126. The wireless network 118 is coupled to the packet-switched network 104 via a communication link 120.

In one embodiment, a user element connects to the packet-switched network 104 through a circuit-switched connection with a border element. In another embodiment, a user element connects to the network 104 through an IP connection with a border element. In other embodiments, a user element may connect to a border element via a Signaling System 7 (SS7) connection, a Digital Subscriber Line (DSL) connection, a cable television connection, a customer managed router connection, a customer managed gateway connection, a local area network connection, a frame relay (FR) connection, an asynchronous transfer mode (ATM) connection, and like access technologies as known in the art. Those skilled in the art will appreciate that numerous other techniques for establishing a connection between a user element and a border element exist in the art. A user element may connect to the PSTN 106 or the wireless network 118 in a well known manner.

Some of the user elements 102 (e.g., TDM phones) connect to a border element through an edge communication link via a TDM Private Branch Exchange (PBX) 124. Others of the user elements 102 (e.g., an IP phone) connect to a border element through an edge communication link via an IP Private Branch Exchange (IP-PBX) 122. Still others of the user elements 102 (e.g., computer) connect to a border element through an edge communication link directly. Others of the user elements 102 (e.g., ISDN phone) connect to a border element through an edge communication link via a terminal adapter (TA) 132.

In accordance with the invention, users begin a call using the communication system 100 by registering endpoints (e.g., user elements 102) with the controller 114. A user may register endpoints that are coupled to any of the packet-switched network 104, the PSTN 106, and the wireless network 118. The controller 114 is configured to establish a logical communication channel through which one or more initial media streams may propagate. Exemplary media streams include voice streams, digital audio streams (e.g., MP3 streams, REAL AUDIO streams, and the like), video streams (e.g., MPEG streams), and data streams (e.g., instant messaging streams). The initial media streams may be specified by the user during the registration of network endpoints. Once established, the controller 114 implements the logical communication channel using one or more physical links of one or more of the packet-switched network 104, the PSTN 106, and the wireless network 118.

In one embodiment, the controller 114 is configured to bridge one or more new media streams onto the implemented logical communication channel, and/or remove one or more media streams from the implemented logical communication channel, without establishing another logical communication channel. In another embodiment, the controller 114 is configured to switch the implemented logical communication channel to one or more new physical communication links without establishing another logical communication channel. For purposes of clarity by example, the communication system 100 is shown with a single controller 114 that is part of the packet-switched network 104. It is to be understood, however, that the communication system 100 may include one or more controllers and that such controllers may be present in one or more of the packet-switched network 104, the PSTN 106, and the wireless network 118.

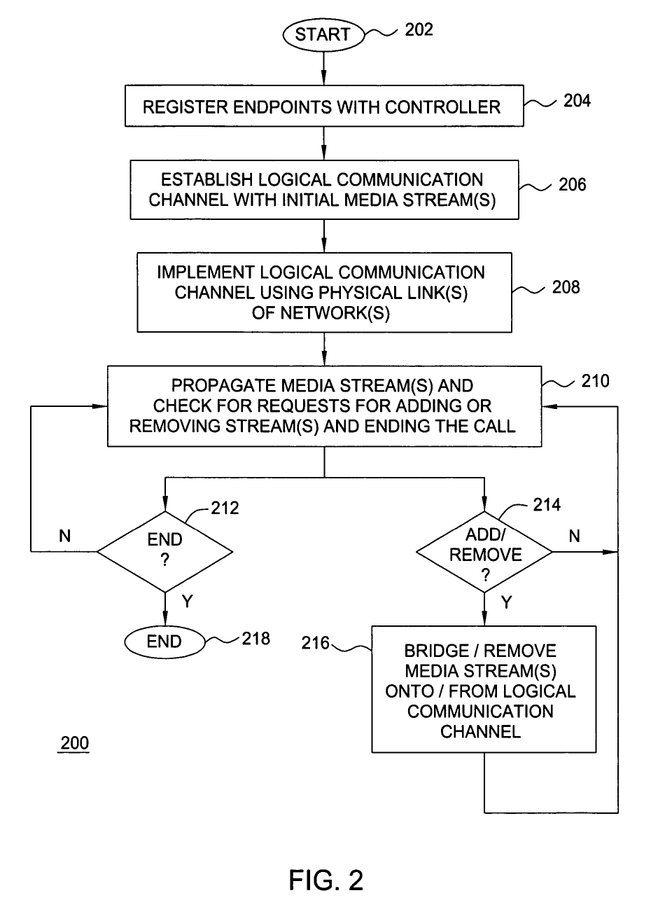

FIG. 2 is a flow diagram depicting an exemplary embodiment of a method 200 for communication amongst a plurality of endpoints in accordance with the invention. The method 200 may be understood with reference to the communication system 100 of FIG. 1. The method 200 begins at step 202. At step 204, endpoints are registered with the controller 114. For example, a user may register a plurality of endpoints (e.g., user elements 102) to begin a call. At step 206, a logical communication channel is established to carry one or more initial media streams. At step 208, the logical communication channel is implemented using one or more physical links of one or more networks. Exemplary physical links include Internet links (computer network links), a wireless communication link, plain old telephone service (POTS) links, and the like.

At step 210, the initial media streams are propagated using the implemented logical communication channel, and checks are performed to identify requests for adding media streams, removing media streams, and ending the call. At step 212, a determination is made as to whether the call has been ended. If so, the method 200 proceeds to end step 218. Otherwise, the method 200 returns to step 210. Contemporaneously with step 212, at step 214, a determination is made as to whether requests have been made for adding and/or removing media streams. If so, the method 200 proceeds to step 216. Otherwise, the method returns to step 210. Requests for adding or removing media streams may be made by the users on the call and may be sent to the controller 114. In one embodiment, users may add and/or remove endpoints after the logical communication channel has been implemented. Such additions or deletions of endpoints may also give rise to the addition/deletion of media streams.

At step 216, one or more media streams are bridged onto and/or removed from the logical communication channel. The bridging/removing of the media streams is done without establishing a new logical communication channel. After step 216, the method 200 returns to step 210. For example, a pair of users may begin a voice call over the packet-switched network 104 using computer terminals. Some time after the logical communication channel has been implemented to carry the voice stream, the users may desire to add background music or watch a video clip while continuing the voice conversation. A user may send a request for a new media stream to the controller 114. The controller 114 then adds the new media stream to the already implemented logical communication channel without establishing a new channel. The logical communication channel would then carry both the original voice stream and a new video or digital audio stream.

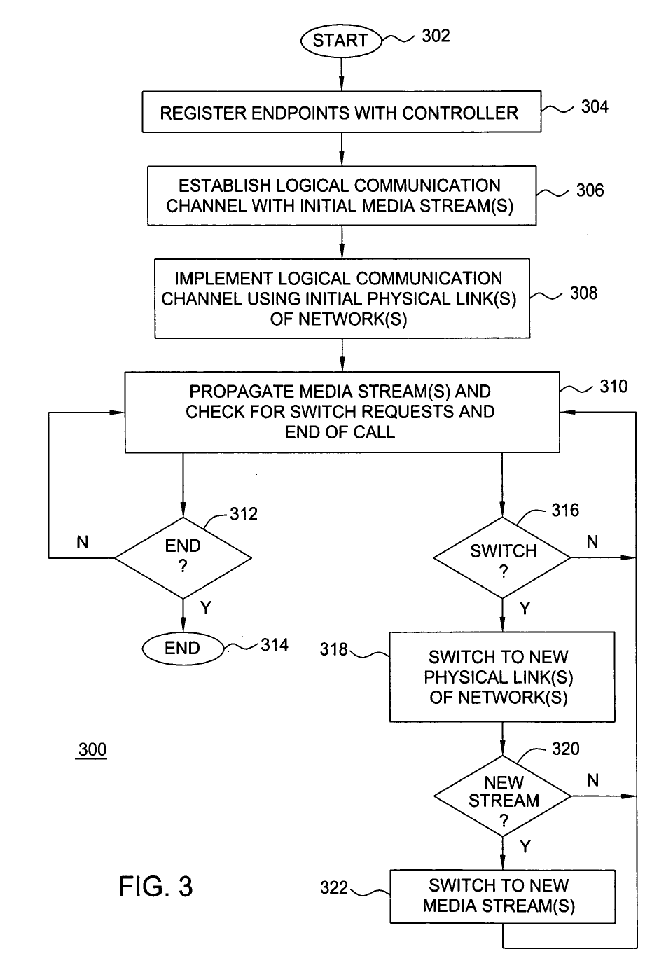

FIG. 3 is a flow diagram depicting another exemplary embodiment of a method 300 for communication amongst a plurality of endpoints in accordance with the invention. The method 300 may be understood with reference to the communication system 100 of FIG. 1. The method 300 begins at step 302. At step 304, endpoints are registered with the controller 114. For example, a user may register a plurality of endpoints (e.g., user elements 102) to begin a call. At step 306, a logical communication channel is established to carry one or more initial media streams. At step 308, the logical communication channel is implemented using one or more initial physical links of one or more networks.

At step 310, the initial media streams are propagated using the implemented logical communication channel, and checks are performed to identify requests for switching physical communication links and for ending the call. At step 312, a determination is made as to whether the call has been ended. If so, the method 300 proceeds to end step 314. Otherwise, the method 300 returns to step 310. Contemporaneously with step 312, at step 316, a determination is made as to whether requests have been made for switching physical communication links. If so, the method 300 proceeds to step 318. Otherwise, the method returns to step 310. Requests for switching physical links made by the users on the call and may be sent to the controller 114. In one embodiment, users may add and/or remove endpoints after the logical communication channel has been implemented. Such additions or deletions of endpoints may also give rise to the switching of communication links.

At step 318, one or more physical links currently being used to implement the logical communication channel are switched to one or more new physical links of one or more networks. The switching of physical links is done without establishing a new logical communication channel. Exemplary physical links include Internet links (computer network links), a wireless communication link, POTS links, and the like. At step 320, a determination is made as to whether any currently propagated media streams must be switched. If not, the method 300 returns to step 310. Otherwise, the method 300 proceeds to step 322, where one or more media streams currently being propagated using the implemented the logical communication channel are switched to one or more new media streams. After step 322, the method 300 returns to step 310.

For example, a pair of users may begin an instant messaging call over the packet-switched network 104 using computer terminals. Some time after the logical communication channel has been implemented to carry the instant messaging data stream, one of the users may desire to switch to using a cellular telephone while continuing the voice conversation. A user may send a request for switching physical links to the controller 114. The controller 114 then switches the physical links being used implemented logical communication channel from an Internet link to a wireless telephone link without establishing a new channel. In addition, the media stream may be switched from an instant messaging data stream to a voice stream.

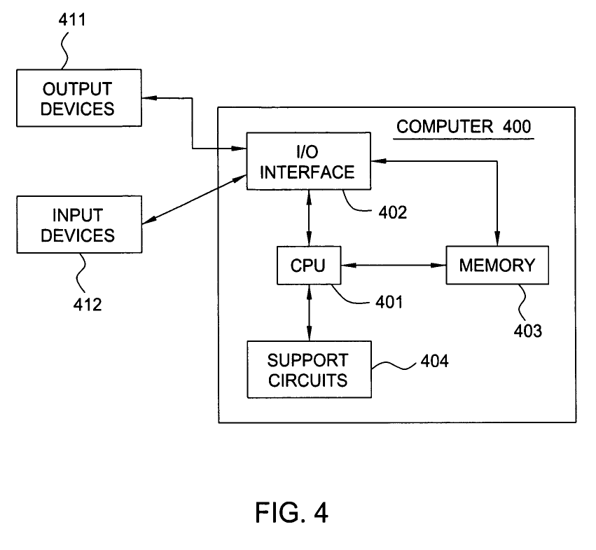

FIG. 4 is a block diagram depicting an exemplary embodiment of a computer 400 suitable for implementing the processes and methods described herein. For example, the computer 400 may be used to implement the controller 114, border elements 108, core elements 110, and servers 112 of FIG. 1. The computer 400 includes a central processing unit (CPU) 401, a memory 403, various support circuits 404, and an I/O interface 402. The CPU 401 may be any type of microprocessor known in the art. The support circuits 404 for the CPU 401 include conventional cache, power supplies, clock circuits, data registers, I/O interfaces, and the like. The I/O interface 402 may be directly coupled to the memory 403 or coupled through the CPU 401. The I/O interface 402 may be coupled to various input devices 412 and output devices 411, such as a conventional keyboard, mouse, printer, display, and the like.

The memory 403 may store all or portions of one or more programs and/or data to implement the processes and methods described herein. Although one or more aspects of the invention are disclosed as being implemented as a computer executing a software program, those skilled in the art will appreciate that the invention may be implemented in hardware, software, or a combination of hardware and software. Such implementations may include a number of processors independently executing various programs and dedicated hardware, such as ASICs.

The computer 400 may be programmed with an operating system, which may be OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 403. The memory 403 may include one or more of the following random access memory, read only memory, magneto-resistive read/write memory, optical read/write memory, cache memory, magnetic read/write memory, and the like, as well as signal-bearing media as described below.

An aspect of the invention is implemented as a program product for use with a computer system. Program(s) of the program product defines functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to embodiments of the present invention, other and further embodiments of the invention may be devised without departing from the basic scope thereof, and the scope thereof is determined by the claims that follow.

1. A method of communication amongst a plurality of endpoints, comprising:
establishing a logical communication channel amongst said plurality of endpoints;
implementing said logical communication channel using at least one physical communication link of at least one communication network;
propagating, at a first time, at least one initial media stream within said logical communication channel; and
at a second time, at least one of: (a) bridging at least one media stream onto said logical communication channel and (b) removing at least one media stream from said logical communication channel.

2. The method of claim 1, further comprising:
registering said plurality of endpoints with a service provider prior to said logical communication channel being established.

3. The method of claim 1, further comprising:
at least one of adding at least one endpoint to, and removing at least one endpoint from, said plurality of endpoints at any time after said first time.

4. The method of claim 1, wherein each of said plurality of endpoints comprises one of a user element and a network element.

5. The method of claim 1, wherein each said at least one communication network comprises one of a packet-switched network, a circuit-switched network, and a wireless communication network.

6. The method of claim 1, wherein each said physical communication link comprises one of an Internet link, a wireless communication link, and a plain old telephone service (POTS) link.

7. The method of claim 1, wherein each said at least one media stream and each said at least one additional media stream comprises one of a voice stream, a digital audio stream, a video stream, and a data stream.

8. The method of claim 7, wherein said data stream comprises an instant messaging stream.

9. A method of communication amongst a plurality of endpoints, comprising:
establishing a logical communication channel amongst said plurality of endpoints;
implementing said logical communication channel using a first physical communication link;
propagating, at a first time, a first media stream within said logical communication channel; and
switching, at a second time, said logical communication channel from said first physical communication link to a second physical communication link without establishing another logical communication channel.

10. The method of claim 9, further comprising:
switching, at said second time, said first media stream to a second media stream without establishing another logical communication channel.

11. The method of claim 9, further comprising:
registering said plurality of endpoints with a service provider prior to said logical communication channel being established.

12. The method of claim 9, further comprising:
at least one of adding at least one endpoint to, and removing at least one endpoint from, said plurality of endpoints at any time after said first time.

13. The method of claim 9, wherein each of said plurality of endpoints comprises one of a user element and a network element.

14. The method of claim 9, wherein said first physical communication link comprises one of an Internet link, a wireless communication link, and a plain old telephone service (POTS) link, and said second physical communication link comprises another of said Internet link, said wireless communication link, and said plain old telephone service (POTS) link.

15. The method of claim 9, wherein each said first media stream comprises one of a voice stream, a digital audio stream, a video stream, and a data stream, and said second media stream comprises another of said digital audio stream, said video stream, and said data stream.

16. A communication system, comprising:
at least one communication network for establishing a logical communication channel amongst a plurality of endpoints, said logical communication channel propagating at least one media stream, said logical communication channel using at least one physical communication link of said at least one communication network; and
a controller for, subsequent to said logical communication channel being established, at least one of: bridging at least one media stream onto said logical communication channel and (b) removing at least one media stream from said logical communication channel.

17. The system of claim 16, wherein each said at least one communication network comprises one of a packet-switched network, a circuit-switched network, and a wireless communication network.

18. The system of claim 16, wherein each said physical communication link comprises one of an Internet link, a wireless communication link, and a plain old telephone service (POTS) link.

19. A communication system, comprising:
at least one communication network for establishing a logical communication channel amongst a plurality of endpoints, said logical communication channel propagating a first media stream, said logical communication channel using a first physical communication link of said at least one communication network; and
a controller for switching, at a second time, said logical communication channel from said first physical communication link to a second physical communication link without establishing another logical communication channel.

20. The system of claim 19, wherein said controller is further configured to:
switch, at said second time, said first media stream to a second media stream without establishing another logical communication channel.

21. The system of claim 19, wherein said first physical communication link comprises one of an Internet link, a wireless communication link, and a plain old telephone service (POTS) link, and said second physical communication link comprises another of said Internet link, said wireless communication link, and said plain old telephone service (POTS) link.
